(19) United States
(12) Patent Application Publication
(10) Pub. No.: US 2016/0288913 A1
(43) Pub. Date: Oct. 6, 2016

(54) GAS MIXING PUMP, PARTICULARLY FOR A HEATING SYSTEM

(71) Applicant: LIEBHERR-AEROSPACE TOULOUSE SAS, Toulouse (FR)

(72) Inventor: Antoine PEYRE, Albi (FR)

(73) Assignee: LIEBHERR-AEROSPACE TOULOUSE SAS, Toulouse (FR)

(21) Appl. No.: 14/903,797

(22) PCT Filed: Jul. 9, 2014
(86) PCT No.: PCT/FR2014/051762

§ 371 Date: Mar. 15, 2016

(30) Foreign Application Priority Data
Jul. 10, 2013 (FR) 13 56776

(51) Int. Cl. B64D 13/08; G05D 23/13

(52) U.S. Cl. CPC B64D 13/08; G05D 23/138

(57) ABSTRACT

A mixing pump (2) according to the invention comprises:
an air duct, referred to as a cool air duct;
an air intake (10), referred to as a hot air intake, leading to the cool air duct;
as well as means for injecting air from the hot air intake (10) into the cool air duct. The hot air intake (10) leads to a chamber (16) arranged at least partially in the cool air duct.

The injection means have at least one opening (30) for connecting the interior of the chamber (16) to the interior of the cool air duct, and means (12) for modifying the flow area through the at least one opening connecting the interior of the chamber (16) to the interior of the cool air duct.

### FIELD OF THE INVENTION

The present invention relates to a gas mixing pump, particularly one intended for a heating system.

### BACKGROUND

The scope of the invention is more particularly the management of air in a cockpit or cabin (for simplicity, cabin is used for both hereinafter) of an aircraft, for example a helicopter but also an airplane. To heat the interior of a cabin, it is known to collect the hot air exiting the engines and recover the unused calories to heat the cabin of the corresponding aircraft.

The hot air exiting the engine cannot be used directly to heat the cabin. This air is at too high a pressure and at too high a temperature to be sent to a cabin as is. This pressurized hot air is therefore mixed with cool air at a lower pressure and temperature collected from outside the cabin.

A position control valve can be used to vary the temperature of the air injected into the cabin. Such a valve is usually located on a hot air pipe upstream of a device for mixing hot air and cold air, hereinafter called a mixing pump, and is for example actuated electrically.

A mixing pump comprises for example a hot air injector, for example having a constant flow area, arranged in a cool air duct. As the hot air is at a relatively high pressure, it carries the cool air along with it when injected into the cool air duct and mixes with the cool air before being introduced into the cabin of the aircraft. In such a system, when a control valve changes the flow of hot air injected into the cool air duct upstream of the injector, said valve creates a corresponding loss of pressure and thus affects the pressure of the hot air flow at the injector.

In a mixing pump such as that described in the preceding paragraph, when the flow of hot air is reduced this also lowers the hot air pressure in the injector, and thus the air injection speed, which can then disrupt the pumping effect, meaning that the hot air flow out of the injector no longer has enough velocity to carry sufficient cool air along with it. The exiting air is then too hot (no cool air in the outgoing stream), which can cause a shutdown of the heating system to avoid overheating the components located downstream of the mixing pump.

A prior art mixing pump is disclosed for example in document FR 626 267.

Document EP 2150867 also discloses a mixing pump. The technical problem leading to the invention described in this prior art document is to provide a gas mixing pump which enables changing the air pressure delivered from the pump according to a setpoint value. This document shows a pump comprising a gas mixing chamber; lines supplying said chamber with HP (High Pressure) and IP (Intermediate Pressure) gas, leading into the mixing chamber; an outlet pipe for the mixed gases; a pneumatic actuator arranged in said HP gas supply line, comprising a movable piston integral with a valve which is positioned in said line to determine the area of flow of HP gas into said mixing chamber, a control chamber of said movable piston supplied with pressure which determines the position of said movable piston; a pneumatic circuit arranged between a pressure source and said control chamber, said pneumatic circuit comprising at least one arranged leak valve adapted to generate a leak in the pneumatic circuit in order to modify the pressure supplied to said control chamber.

In other technical fields, systems for mixing hot air and cool air also exist. In motor vehicle engines for example, document FR 2 026 587 provides a temperature-responsive valve cage comprising an oscillating valve arranged to regulate the flow of at least two fluid streams entering a common pipe at different but variable temperatures. A temperature-sensitive element is located in the common pipe for determining the position of the valve, this element being arranged so as to maintain a predetermined range of temperatures in the fluid mixture passing through the common pipe, the temperatures of the incoming streams being such that they allow maintaining this predetermined temperature range. The temperature adjustment occurs here over a reduced predetermined range. The system does not allow having a wide range of output temperatures. In addition, it does not provide suction and therefore there is no pumping effect during operation.

Document WO 98/37312 relates to a control valve for a combustion gas turbine, intended for regulating the inlet temperature of an indirect fired gas turbine, located at the turbine expander inlet. This control valve is useful in energy production systems with an indirect-fired gas turbine. Again, the system described does not allow suction and therefore no pumping effect. On the other hand, unlike the previous document, it does allow varying the output temperature setting.

### SUMMARY

The purpose of the present invention is to provide a mixing pump, in other words a system performing injection by a pumping effect in which forced intake of hot air for example induces suction of a stream of gas cool air for example, allowing a range of operating temperatures that is as wide as possible without disrupting the pumping effect of the corresponding heating system, in particular for a heating system. Advantageously, the proposed system will work just as well when the heating requirements are demanding (the outside temperature and thus the cool air temperature is very low, for example 40° C.) as when the heating requirements are moderate (moderate outside temperature, for example 15° C.).

Preferably, the proposed mixing pump is of as simple a design as possible. Its size and/or weight are advantageously moderate. The pump of the invention is also preferably easy to regulate and/or highly reliable and/or of moderate cost.

To this end, the present invention provides a mixing pump comprising an air duct, referred to as a cool air duct, an air intake leading to the cool air duct, referred to as a hot air intake, as well as means for injecting air from the hot air intake into the cool air duct.

According to the invention, the hot air intake leads to a chamber arranged at least partially in the cool air duct, and the injection means have at least one opening for connecting the interior of the chamber to the interior of the cool air duct, as well as means for modifying the flow area through the at least one opening connecting the interior of the chamber to the interior of the cool air duct.

This creates an injection system with variable flow area, in which the hot air is placed in a chamber under a high pressure corresponding to the hot air delivery pressure. Thus, even when the flow area for the hot air is small, the pressure of the hot air remains high which allows achieving significant injection speeds sufficient to draw a mass of cool air along with it. The proposed system thus solves problems related to disruption of the pumping effect.

To encourage a good mix of the two gas streams, the cool air duct is a pipe extending longitudinally in a first direction, and it is arranged that the chamber has a circular cylindrical tubular shape extending in a second direction substantially perpendicular to the first direction. For good distribution of the stream of hot air in the stream of cool air, the chamber is preferably formed inside a tube traversing the cool air duct.

This is a chamber placed within the cool air duct, because its dimensions are not insignificant compared to those of the cool air duct. As a non-limiting example, the chamber has for example a diameter of between ⅛th and one-half the diameter of the cool air duct at the location of said chamber. In addition, the chamber has relatively large dimensions compared with the diameter of each opening. For example, it may be provided that the chamber has a diameter which is at least twice that of the largest opening. It is thus possible to ensure a sufficient flow of hot air even when there are several openings.

For better distribution of the stream of hot air in the stream of cool air, and for the best possible adaptation of the hot air flow area, a plurality of openings are preferably formed for connecting the interior of the chamber to the interior of the cool air duct. The system is then, as mentioned above, an injection system with variable flow area but also a multi-injector system.

In a mixing pump of the invention, to facilitate the suction of cool air by the hot air exiting the chamber through each opening, it is preferable that each opening be formed in the downstream side of the chamber relative to the flow of air in the cool air duct.

A preferred embodiment provides that the at least one opening is formed in a fixed wall, and that the means for modifying the flow area through the opening connecting the interior of the chamber to the interior of the cool air duct comprise a movable wall matching the shape of the fixed wall and slidable relative to the fixed wall so as to cover each opening of the fixed wall to a greater or lesser extent. This embodiment allows creating a compact mixing pump of reduced weight. For this advantageous embodiment, when the duct is a pipe extending longitudinally in a first direction and the chamber has a circular cylindrical tubular shape extending in a second direction substantially perpendicular to the first direction, then the means for modifying the flow area through the at least one opening comprise, for example, a valve in the form of a circular cylindrical tube having an outer diameter substantially corresponding to the inner diameter of the chamber and having at least one window of a shape and position such that in one position of the valve each opening of the chamber is covered and in another position of the valve each opening is completely uncovered. This achieves a sleeve/valve type of system comparable to a revolving valve system (also called a plug valve). It is also possible for the mixing pump according to the invention to comprise an actuator for rotating the valve so as to gradually expose each opening of the chamber, from a fully covered position to a fully uncovered position. The actuator is, for example, controlled by an acquisition and control system cooperating with a temperature sensor placed downstream of the injection system.

The invention further relates to a heating system for an aircraft, in particular for a helicopter, characterized in that it comprises a mixing pump as described above.

### BRIEF DESCRIPTION OF THE DRAWINGS

Details and advantages of the invention will become apparent from the following description, with reference to the accompanying drawings in which:

FIG. 1 is a schematic diagram illustrating the invention,

FIG. 2 is a longitudinal sectional view of a preferred embodiment of a mixing pump of the invention,

FIG. 3 is a longitudinal sectional perspective view of the mixing pump of FIG. 2,

FIG. 4 is a cross-sectional perspective view of the pump of FIGS. 2 and 3, and

FIGS. 5A to E illustrate the operating principles of a mixing pump illustrated in the preceding figures.

### DETAILED DESCRIPTION OF THE PREFERRED EMBODIMENTS

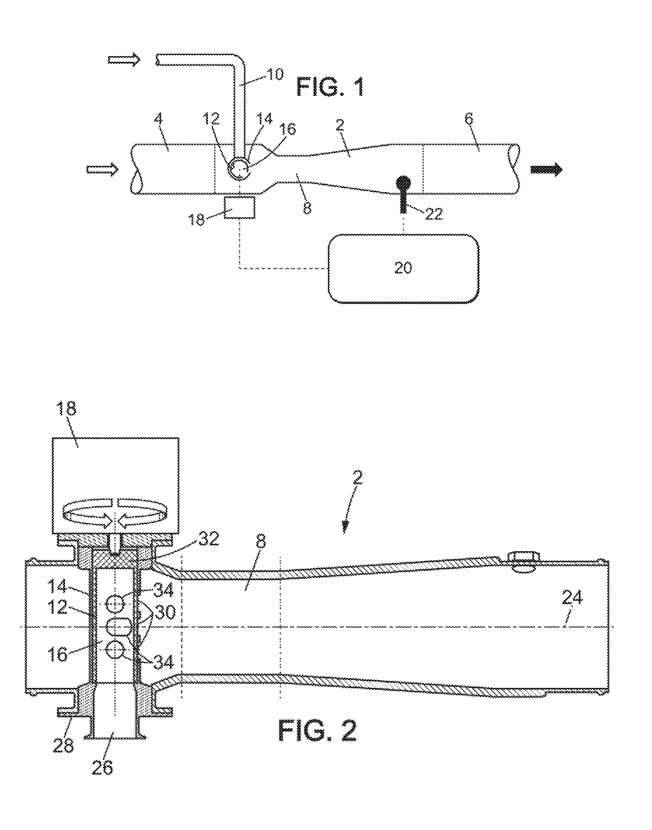

FIG. 1 illustrates the general structure of a preferred embodiment of a mixing pump 2 according to the invention.

The mixing pump 2 shown is mounted downstream of a cool air inlet 4 and upstream of a temperate air outlet 6. It comprises a main pipe, within which is located a mixing section 8, a hot air intake 10, and means for mixing a gas stream coming from the cool air inlet 4 with a gas stream guided by the hot air intake 10 to the mixing pump 2. The mixing means comprise a valve 12 arranged in a sleeve 14 and defining a chamber 16.

An actuator 18 is provided for adjusting the position of the valve 12 in the sleeve 14. The actuator 18 is controlled by an acquisition and control system 20 associated in particular with a temperature sensor 22. The actuator 18 is preferably electric. However, depending on the environment, it is possible to have for example a pneumatic device with for example a single acting pneumatic actuator, a connecting rod, and an electro-pneumatic regulator for varying the pressure in a chamber of the pneumatic actuator. It is thus possible to adjust the position of the valve 12 via the connecting rod.

FIG. 2 shows the mixing pump 2 of FIG. 1 in more detail. One will recognize a longitudinal pipe, the main pipe, with its longitudinal axis 24. It is arranged so that air flows in the main pipe from left to right in FIGS. 1 and 2, as indicated by the arrows in FIG. 1. When air leaves the air inlet 4, it enters a cool air duct in which the hot air intake 10 arrives further downstream. The cool air duct then narrows towards the mixing section 8. A widening area is provided between the mixing section 8 and a connecting area leading to the temperate air outlet 6.

Downstream of the cool air duct are the mixing means with the sleeve 14 and valve 12.

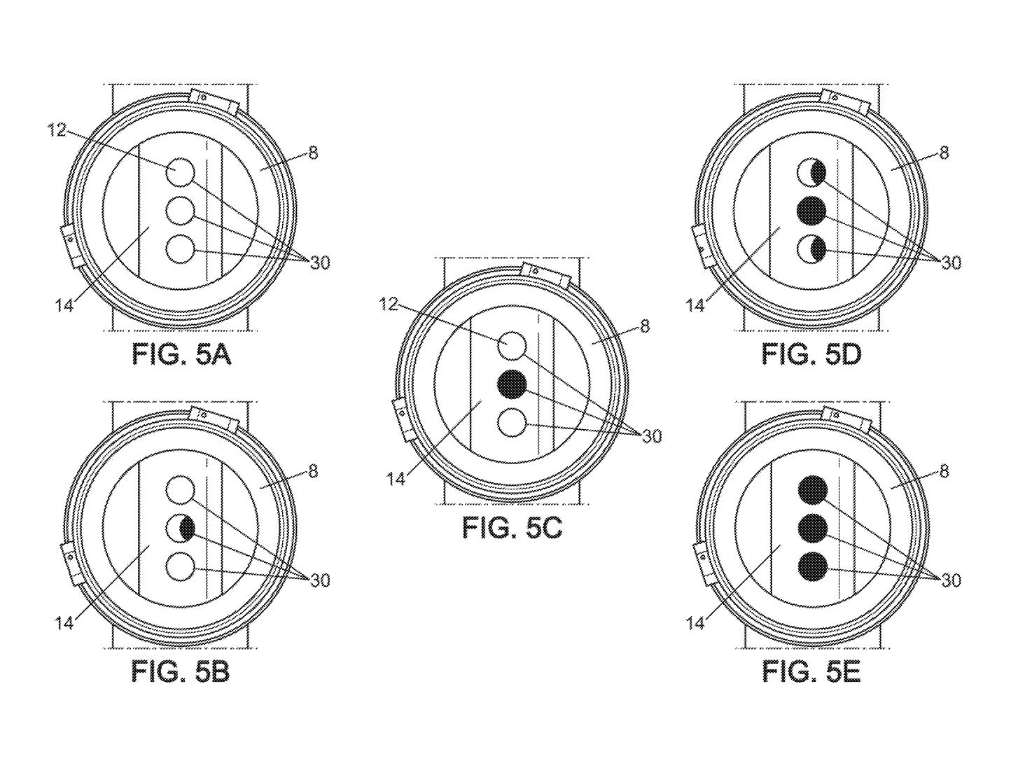

The sleeve 14, in the preferred embodiment illustrated here, forms a chamber 16 supplied with hot air through an inlet 26 connected to the hot air intake 10 shown in FIG. 1. The connection to the hot air intake 10 is achieved for example by means of a flange 28. The sleeve 14 is in the form of a circular cylindrical tube traversing the downstream end of the cool air duct, preferably extending substantially perpendicularly to the longitudinal axis 24 (the axis of the sleeve 14 preferably intersects the longitudinal axis 24 but for space-saving reasons or other reasons an offset may be considered). Openings 30, here three in number, are formed in the wall of the sleeve 14 so as to provide a connection between the interior of the chamber 16 and the interior of the cool air duct. As illustrated in FIGS. 5A to E, these openings 30 are, for example, substantially circular (front view). They are arranged in the wall of the sleeve 14 and therefore of the chamber 16 which is on the downstream side of the flow of cool air in the cool air duct. For air flow purposes, these openings 30 are preferably centered relative to the longitudinal axis 24 and where appropriate to the plane containing the longitudinal axis 24 and the (transverse) axis of the sleeve 14. These openings 30 are formed in the downstream side with respect to the flow of gas in the cool air duct.

The sleeve 14 has for example an inner diameter, corresponding to the diameter of the chamber 16, which for example corresponds to one fourth of the inner diameter of the cool air duct in which it is located. This diameter of the sleeve 14 is given as an illustration. It is the task of a person skilled in the art to define its dimensions according to the performance to be achieved. This diameter is not insignificant compared to the diameter of the cool air duct and is relatively large, for example at least double, compared with the diameter of the openings providing communication between the chamber 16 and the cool air duct.

The valve 12 is arranged inside the sleeve 14. It has a circular cylindrical wall whose outer diameter substantially corresponds to the inner diameter of the sleeve 14 so as to be slidable within the sleeve 14 while being guided by the latter. For good sliding and good guidance, the valve 12 may be made for example of graphite and the sleeve 14 of stainless steel. The cylindrical wall of the valve 12 is open at its end facing the inlet 26 and is closed off at its opposite end by a bottom 32. The bottom is used to connect the valve 32 to the actuator 18 which rotates the valve 32 about its axis (which corresponds to the axis of the sleeve 14).

The valve 12 is intended to allow fully closing the openings 30 and thus preventing any gas flow from the chamber 16 to the interior of the cool air duct, but also to allow completely uncovering the openings 30 so that air from the chamber 16 can flow into the cool air duct with a maximum flow area (made possible by the openings 30). All intermediate positions should preferably be possible: continuously adjustable positions of the valve 12 in its sleeve 14 or predefined positions enabling incremental adjustment of the valve 12.

To allow covering and uncovering the openings 30 to a greater or lesser extent, the valve 12 comprises windows 34 illustrated in FIGS. 2 to 5. In the illustrated embodiment, there are three windows 34, each corresponding to an opening 30. One will note that the window 34 at the center, between the two other windows 34, has the shape of an oblong hole while the other two windows 34 are substantially circular. As already indicated, the windows 34 are preferably sized so that they can each leave entirely unobstructed the passage formed by the corresponding opening 30 between the chamber 16 and the cool air duct.

Having a window 34 in the shape of an oblong hole allows uncovering one opening 30 before the others, while also allowing the possibility of fully uncovering all three openings 30. FIGS. 5A to E illustrate the cooperation of the sleeve 14 with its valve 12.

FIG. 5A illustrates a position where the valve 12 fully covers the openings 30. No gas can flow from the chamber 16 to the cool air duct even when the gas (air) in the chamber 16 is under pressure (typically several bars−1 bar=105 Pa).

In the position illustrated in FIG. 5B, only the opening 30 in the center is partially uncovered. A passage of small cross-section allows the pressurized gas in the chamber 16 to flow into the cool air duct.

In the proposed embodiment of the invention, it is provided that the central opening 30 is entirely uncovered before the side openings 30 begin to be uncovered. FIG. 5C illustrates the position in which the central opening 30 is fully open but the two side openings 30 are completely covered.

FIG. 5D shows the entirely uncovered opening 30 and the side openings 30 still partially obstructed, while in FIG. 5E all the openings 30 are fully uncovered.

The transition from the position shown in FIG. 5A to the position shown in FIG. 5E can correspond, for example, to a 90° rotation of the valve 12. This value is of course given purely as a non-limiting illustration.

The skilled person will understand that the “rule of opening” for the openings 30 is only one example application. It could be arranged to have the three openings 30 open simultaneously, have them open in succession, or . . . .

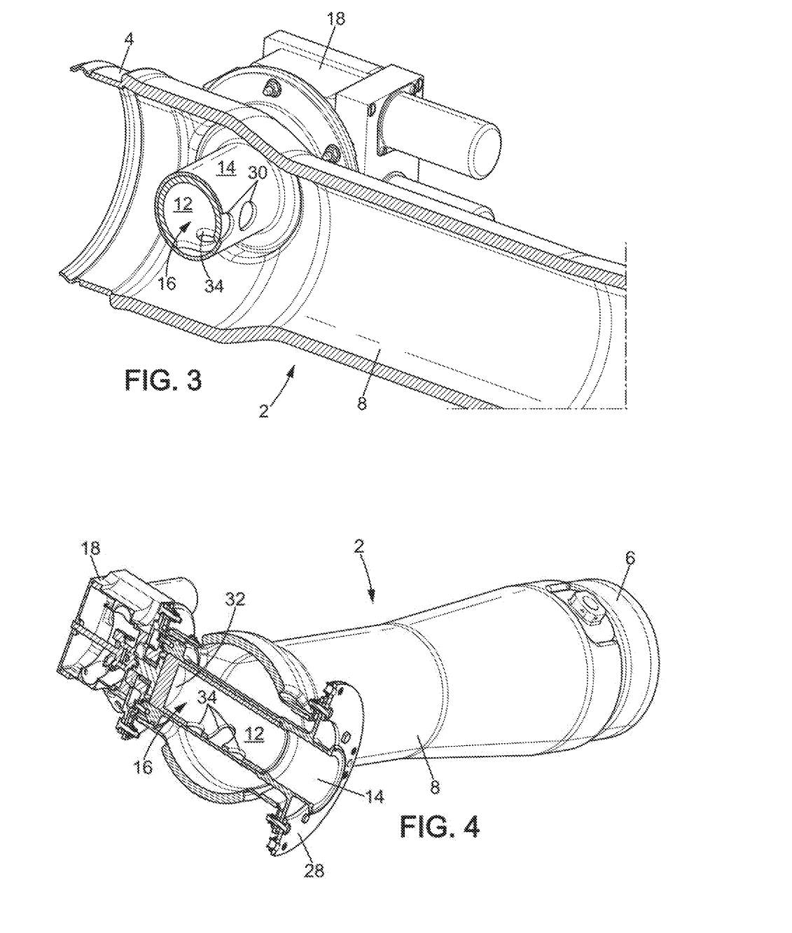

FIG. 3 shows a perspective view of a connection of the mixing pump 2 described above with the air inlet 4, while FIG. 4 illustrates the connection of this mixing pump 2 with a temperate air outlet 6. These views also provide a better view of the forms of the various elements used in the illustrated embodiment of the invention.

As is apparent from the above description, the mixing pump 2 provided is a multi-injector mixing device with a variable injection flow area. Each opening 30 forms an injector, and it has been seen that the valve 12 allows varying the flow area through each of these injectors.

Downstream of the chamber 16 and the mixing means for the two gas streams, the cool air duct of the mixing pump 2 narrows towards the mixing section 8. This mixing section 8 is supplied with gas at a high pressure and high temperature (hereinafter referred to as hot air) flowing in through the hot air intake 10 via chamber 16 and traversing at least one opening 30, and with gas at ambient pressure and temperature (hereinafter referred to as cool air) which arrives through the air inlet 4.

The system for injecting hot air into the cool air duct is integrated into the cool air duct and traverses it from side to side. Alternatively, one could envisage a system extending partially into the cool air duct, for example for only a portion of the diameter of this duct.

In operation, pressurized hot air reaches chamber 16 through inlet 26, and exits chamber 16 radially in the desired direction of outflow of the temperate air resulting from the mixture of hot air with cool air. The flow area of the hot air passage is controlled by the valve 12, itself controlled by the actuator 18. The pressurized hot air exiting through the injectors (openings 30) carries the cool air along with it and mixes with it in the mixing section 8 more or less along the longitudinal direction of the longitudinal axis 24 of the main pipe.

The injection system presented above with reference to the accompanying drawing allows high pressure injection of hot air, along the entire rotational path of the valve 12, that is symmetrical with respect to a plane containing an axis of symmetry of the main pipe and/or cool air duct and perpendicular to the axis of rotation of the valve 12. This is achieved through the arrangement of the openings 30 in the sleeve 14. It is preferable in an application for a heating system of an aircraft, for example a helicopter, to first open the hot air injectors near the axis of revolution of the cool air duct (or mixing section) and then gradually and symmetrically the injectors more distant from this axis of revolution. A greater number of injectors can thus be provided (compared to the illustrated embodiment) so as to adapt for example to a larger pipe size or to fine tune the flow of hot air. Conversely, it is also possible in some configurations have only one or two openings 30.

The proposed system allows having a zero injection flow area and a gradual transition to a maximum injection flow area corresponding to the injectors (openings 30) being fully open.

A mixing pump according to the invention allows mixtures over a wide range of operating temperatures and thus provides good control of the temperature exiting the pump regardless of external conditions and the characteristics of the hot air coming from the engine. One needs to dimension the openings in the sleeve to ensure sufficient heating. Conversely, for moderate heating, the system design avoids issues of disrupting the pumping effect. In fact, the hot air pressure in the chamber depends only on the pressure in the hot air intake pipe and scarcely varies with the flow area which allows the hot air to flow into the mixing section. When the injection flow area is small, the injection pressure remains significant and injection speeds sufficient to carry along the cool air are obtained.

The proposed system also provides savings in both weight and size, in relation to comparable prior art systems. The proposed system is also simple in design and reliable.

Of course, the invention is not limited to the preferred embodiment described above with reference to the accompanying drawings and the variants discussed, but also concerns all variant embodiments within the reach of the skilled person that fall within the scope of the following claims.

1. A mixing pump (2) comprising a cool air duct, a hot air intake (10) leading to the cool air duct, and means for injecting air from the hot air intake (10) into the cool air duct,
wherein the hot air intake (10) leads to a chamber (16) arranged at least partially in the cool air duct, and the injection means have at least one opening (30) for connecting the interior of the chamber (16) to the interior of the cool air duct as well as means (12) for modifying a flow area through the at least one opening (30) connecting the interior of the chamber (16) to the interior of the cool air duct.

2. The mixing pump (2) according to claim 1, wherein the cool air duct is a pipe extending longitudinally in a first direction (24) and wherein the chamber (16) has a circular cylindrical tubular shape extending in a second direction substantially perpendicular to the first direction (24).

3. The mixing pump (2) according to claim 1, wherein the chamber (16) is formed inside a tube traversing the cool air duct.

4. The mixing pump (2) according to claim 1, wherein the chamber has a diameter of between ⅛th and one-half a diameter of the cool air duct at the location of said chamber.

5. The mixing pump (2) according to claim 1, wherein a plurality of openings (30) are formed for connecting the interior of the chamber (16) to the interior of the cool air duct.

6. The mixing pump (2) according to claim 5, wherein each opening (30) is formed in a downstream side of the chamber (16) relative to a flow of air in the cool air duct.

7. The mixing pump (2) according to claim 5, wherein the at least one opening (30) is formed in a fixed wall, and wherein the means for modifying the flow area through the opening (30) connecting the interior of the chamber (16) to the interior of the cool air duct comprise a movable wall matching the shape of the fixed wall and slidable relative to the fixed wall so as to at least partially cover each opening (30) of the fixed wall.

8. The mixing pump (2) according to claim 7, wherein the means for modifying the flow area through the at least one opening (30) comprise a valve (12) in the form of a circular cylindrical tube having an outer diameter substantially corresponding to the inner diameter of the chamber (16) and having at least one window (34) of a shape and position such that in one position of the valve (12) each opening (30) of the chamber (16) is covered and in another position of the valve (12) each opening (30) is completely uncovered.

9. The mixing pump (2) according to claim 8, comprising an actuator (18) for rotating the valve (12) so as to gradually expose each opening (30) of the chamber (16), from a position where each opening (30) is covered to a position where each opening (30) is fully uncovered.

10. A heating system for an aircraft, comprising a mixing pump (2) according to claim 1.
